(19) United States
(12) Patent Application Publication
(10) Pub. No.: US 2016/0090923 A1
(43) Pub. Date: Mar. 31, 2016

(54) PAYMENT ENFORCEMENT SYSTEM

(71) Applicant: Sekurus International, Inc., Mississauga (CA)

(72) Inventor: Basel Al Salah, Mississauga (CA)

(73) Assignee: Sekurus International, Inc., Mississauga (CA)

(21) Appl. No.: 14/869,433

(22) Filed: Sep. 29, 2015

Related U.S. Application Data
(60) Provisional application No. 62/057,138, filed on Sep. 29, 2014.

(51) Int. Cl. F02D 35/00; G06Q 20/14

(52) U.S. Cl. CPC F02D 35/00; G06Q 20/14

(57) ABSTRACT

A system to encourage on time payments includes electronic apparatus coupled to a critical system of certain equipment. For example, the starter system of an automobile. Apparatus includes a mechanism whereby a user-operator is able to enter a command. Entry of a command serves as an indication that a payment has been made and enables further use of the equipment. On failure to timely make payments, a user is prevented from using the equipment as the apparatus is arranged to disable the equipment by way of the critical system to which it is coupled. Both a user-operator interface and critical system interruption circuit are coupled to a logic processor which is easily mounted onto equipment subject to the program. The use of a gateway system is also disclosed.

Priority is claimed with regard to U.S. Provisional Application No. 62/057,138, “Payment Enforcement System”, filed Sep. 29, 2014, which is incorporated herein by reference in its entirety.

### BACKGROUND OF THE INVENTION

1. Field

The following invention disclosure is generally concerned with electronic systems for disabling equipment in response to failure to make timely payments on a corresponding loan, lease or rental.

2. Related Art

Systems have been introduced to interrupt the ignition system of an automobile on a regular, timed interval. To re-enable the car, a user is required to return to a payment center, make a payment, and have an agent reset the interrupt mechanism for a renewed timed interval. The system can only be reset by an authorized agent as it requires a key held in escrow at the payment center. While the system is effective in encouraging customers to repay their auto loans in timely fashion, it has extreme overhead considerations. The system requires a customer to travel to the payment center each payment period of the loan. Of course, this prevents the user from taking extended travel without first making an advanced payment. In addition, a user must arrive at the payment center during the hours in which it is open. Still further, a user must wait to receive the attention of the agent. As these problems pose considerable inconvenience, these systems suffer from limited utility. It is desirable to automate the reset process so a user is not required to travel to a payment center.

Monthly payments to utility companies are made with very high reliability. This is partly due to the threat of service cut-off. Failure to pay a phone bill, will result in loss of telephone services. Thus, phone bills are paid regularly because failure to do so has immediate and tangible results. Monthly payments on an automobile loan are not likely to be as regular. Although a car may be repossessed, the process is expensive and complex and thus the threat of doing so is less immediate than telephone service cut-off To encourage reliable loan re-payments, it is desirable to have a ‘service’ cut-off for equipment related to loans.

Techniques have been discovered which provide very novel uses of automobile ignition or starter interruption systems, particularly with respect to those which may be reset with minimal intrusion and burden upon a user's freedom. While systems and inventions of the art are designed to achieve particular goals and objectives, some of those being no less than remarkable, these inventions have limitations which prevent their use in new ways now possible. These prior art ideas are not used and cannot be used to realize the advantages and objectives of the present invention.

### OBJECTIVES OF THE INVENTION

It is a primary object of the invention to provide systems to improve timely repayment of a loan.

It is an object of the invention to provide a system which can be operated without having to bring equipment to a predetermined location.

It is an object of the invention to provide systems to enable and disable equipment in response to receipt of loan payments.

It is a further object to provide systems which interrupt a critical system of equipment in response to a failure to receive a command in due time.

### SUMMARY OF THE INVENTION

In accordance with the foregoing objectives, provided is a repayment system including devices for and methods of interrupting a critical system of equipment in response to failure to make timely payments.

A critical system interruption circuit in communication with a logic processing unit operates to disable and enable equipment in response to loan payments being timely made. When a user makes a payment on an outstanding loan, usually a loan related to the equipment, a logic processor is notified of the action. The logic processor drives a switch coupled to a critical system interruption means to enable or disable the equipment in accordance with payment receipt.

In some preferred versions, when a user makes a payment on an outstanding car loan, a command is released to the user. The user then operates a user-operator interface connected to a logic processing unit to convey the command. Once the command is verified, the logic processing unit manipulates the automobile starter circuit to enable the car.

In example, a starter interruption circuit is arranged to disable and enable an automobile in response to loan payments being timely made. When a user makes a loan payment, the command is released to the user from a payment center. The user operates a user interface to convey the command to a logic processing unit. Upon verification, the logic processing unit operates an interruption circuit to enable the automobile for further use. Thus it becomes possible to interrupt service of equipment in response to failure to timely receive payments on a loan associated with the equipment.

In agreement, apparatus of the invention include: a critical system interruption circuit operable for enabling and disabling a critical system of certain equipment; a logic processing unit having a reference command generation and storage facility and comparator. And in some versions, a user interface operable for receiving a command from a user and conveying that command to the logic processing unit is included.

Methods of the invention may be summarized as those which include the steps: computing a payment due deadline, generating a reference command which corresponds to the deadline, receiving a command at a logic processing unit, comparing the received command to the reference command, disabling a critical system if a correct command is not received before a present time exceeds a payment due deadline; enabling a critical system on receipt of correct command; and computing subsequent payment due deadline and generating a reference command which corresponds to the subsequent deadline.

In some preferred uses of systems of the invention, a user who purchases a car from a dealer agrees to have the system installed on the purchased automobile to protect the lender from late payments on an outstanding loan. On initiation, parameters which relate to loan terms, for example total number of payments and payment interval, are loaded into a system memory from a server unit. The logic processing unit computes a deadline time which corresponds to the due date and time for receipt of a payment. When a user makes a payment on time in agreement with loan terms, the system sends a payment confirmation to a mobile application that releases a predetermined alpha-numeric command to the user. The user then sends the command via a wireless interface of his mobile application user interface so that the logic processing unit can process the command for verification. If the command matches a reference command stored or generated within the device, then the logic processing unit puts the starter interruption circuit in a state which enables the car's ignition system. A user who fails to make a payment will not receive the command necessary to ‘unlock’ the system. If the user fails to enter the proper command by the time the deadline passes, the car is put into a disabled state by way of interruption of the starter until payment is made. Thus the logic processing unit is provided an indication that timely payment was made via receipt of a correct command.

The invention thus stands in contrast to methods and devices known. The invention includes a critical system interruption mechanism which can be operated without being returned to the payment center. Systems of the art require returning to a payment center.

A better understanding can be had with reference to the detailed description of preferred embodiments and with reference to the appended drawings. These embodiments represent particular ways to realize the invention and are not inclusive of all ways possible. Therefore, there may exist embodiments that do not deviate from the spirit and scope of this disclosure as set forth by the claims, but do not appear here as specific examples. It will be appreciated that a great plurality of alternative versions are possible. dr

### BRIEF DESCRIPTION OF THE FIGURES OF THE DRAWING

The features, aspects, and advantages of the present invention will become better understood with regard to the following description, appended claims and drawings where:

FIG. 1 is a block diagram which describes arrangement of elements in an apparatus of the invention.

FIG. 2 is a block diagram which describes arrangement of steps in a method of the invention.

FIG. 3 is a block diagram which relates methods and apparatus together.

FIG. 4 is a block diagram which illustrates a vehicle disablement device with a wireless communication gateway.

FIG. 5 is a block diagram which illustrates further details of a user interface mobile application.

FIG. 6 is a block diagram showing the detailed user of interface shown in FIG. 5.

FIG. 7 is a block diagram which the use of triangulation to determine location of the vehicle.

### DETAILED DESCRIPTION OF THE PREFERRED EMBODIMENTS

The above-identified and other deficiencies of prior methods and systems are overcome by the location system of the present invention. In accordance with the present invention, a vehicle location system operates to provide a location of a vehicle if a payment due date associated with the vehicle has passed and a payment has not been received for the vehicle. The vehicle location system operates to provide the equipment's location to a service agency. The service agency can then locate and repossess the equipment. The service agency can be a lender or other party having a security interest in the equipment. Alternatively, the service agency can have a contract with a party who has an interest in the equipment to locate and repossess equipment's for which payments are delinquent. Additionally, the equipment location system can be activated if it is detected that the equipment is being tampered with. The location of the equipment can be determined using global positioning satellites or by triangulation using base stations in mobile radio systems.

By locally activating the location system, the burden of monitoring payments for an equipment by a service agency can be reduced. Further, the cost of the location system is reduced since the location system does not require a receiver to receive information, but instead only requires a transmitter to provide the equipment location to the service agency.

In accordance with one embodiment of the present invention, an equipment disablement device installed in equipment determines whether a certain date has passed. If the certain date has passed the equipment disablement device determines whether a command associated with the date has been previously received by the communication gateway within the equipment that communicates to the disablement device. If a command associated with the date has not been previously received then the equipment disablement device communicates to activate a location system and provides a location of the equipment to a service agency. The service agency can then recover the equipment. Further, if it is detected that the equipment disablement device has been tampered with, the equipment disablement device, or a tamper detection device, can activate location system and provide the location of the equipment to the service agency.

In other embodiments, the present system communicates the status of the disablement device. Furthermore, the system comprises a wireless communication gateway within the equipment that communicates with the disablement device. The wireless communication gateway also communicates to an application on a mobile device with GPS capability to receive a change status command.

In another embodiment, the system comprises a mobile application that wirelessly communicates with the equipment via a wireless communication gateway installed within the equipment. A user interface application is an alternative to a keypad within the equipment. As the wireless communication method, a wireless relay along with blue-tooth can be used.

The present invention, therefore, is looking to reemerge with an upgrade of the systems of the prior art that depend on a keypad, wired system and direct programming of a PC. The present inventive system is managed using a mobile device with a proprietary application that manages the payment command and the disablement device with a communication system or gateway within the equipment. The present invention is quite applicable to use of a smart-phone.

### GLOSSARY

Throughout this disclosure, reference is made to some terms which may or may not be exactly defined in popular dictionaries as they are defined here. To provide more precise disclosure, the following definition of terms are presented with a view to clarity so that the true breadth and scope may be more readily appreciated. Although every attempt is made to be precise and thorough, it is a necessary condition that not all meanings associated with each term can be completely set forth. Accordingly, each term is intended to also include its common meaning which may be derived from general usage within pertinent arts or by dictionary meaning. Where the presented definition is in conflict with a dictionary or arts definition, one must consider the context of use and liberal discretion to arrive at an intended meaning. One will be well advised to err on the side of attaching broader meanings to terms used in order to fully appreciate the depth of the teaching and to understand all intended variations.

### Enable/Disable

Use of the word ‘enable’ or ‘disable’ means to cause a system to become operable or to cause a system to become inoperable in a temporary fashion whereby the state of operability may be toggled therebetween operable and inoperable states.

### Payment Center

A payment center is a facility for receiving payments and dispensing commands in response to said receipt of payments. It may be an automatic or a partially automatic system whereby use of a database and dial-up access with electronic communication or radio frequency transmission of commands is fully anticipated.

### Command

‘Command’ refers to any combination of numbers or letters or even symbols which may be represented in a digital domain such as in ASCII format; the command being represented in binary facilitates manipulation via computer processing means.

### Critical System

‘Critical system’ refers to any system or sub-system which is necessary for the proper function of some related piece of equipment.

### Ignition

‘Ignition’ refers to the entire electrical system of a car and all systems which support causing ignition in an engine, especially the starter system. Although ‘ignition’ generally refers to the portion of electronics dedicated causing a spark to initiate combustion, for purposes of this invention, ‘ignition’ is to be taken quite broadly. For example, if a car is disabled because a fuel pump is rendered inoperative, or if a door or other security system is maintained in a locked condition, it is meant that ‘ignition’ is interrupted. One will appreciate that ignition does not occur when fuel is cut-off thus ignition is interrupted.

### Logic Processing Unit

‘Logic processing unit’ refers to any logic processor, microcontroller, microprocessor or other computer type device operable for executing program command and performing logic operations without limitation to any particular type or class of processor.

### Equipment

‘Equipment’ refers to machinery, instruments, and tools, both mechanical and electronic, which have systems or sub-systems which may be exposed to interruption. Equipment includes things like automobiles; machinery used in factories, such as conveyors and packaging tools; construction tools such as chain saws and jackhammers; instruments used in research facilities such as electron microscopes and spectrometers; and instruments used in hospitals, such as radiometers and gamma knives.

### Automobile

The term ‘automobile’ is intended to include cars, trucks, tractors, cranes, boats, jet-skis, snowmobiles, motorcycles, recreational vehicles, airplanes etc. Each of these types of vehicles is comprised of an ignition system. Although in various parts of the invention reference is made to cars, it is to be appreciated that the invention works equally as well with other types of vehicles and thus automobile is to be interpreted without limit to cars but rather to any vehicle having an ignition system including a starter.

Nouns which are Functional in Nature or Include the Modifier: “Means”

In addition to the terms described above, for purposes of this disclosure full meaning of certain nouns which are functional in nature, a ‘functional noun’, may be more readily appreciated in view of the following note.

A functional noun indicates that something is done, is caused, or simply occurs. Many forms of alternates may be used to accomplish the identical event. The particular choice of an object may be selected in view of a particular task at hand, however, in view of other tasks, one may choose a different object where both objects are useful in producing the mentioned function. Thus, it is not the object onto which importance be placed, but rather the function.

The essence of the invention is not changed by any particular choice of an object. Versions of the invention should not be limited to one particular type of object when a functional noun is used. The limitation described by functional noun is met when the function occurs. Therefore, by use of a functional noun it is meant that any conceivable means for causing the function is part of the invention. Experts will recognize many thousands of possible ways of accomplishing the identical function with alternative objects and it will not serve a further understanding of the invention to attempt to catalogue them. The reader will appreciate that the broadest possible definition of a functional noun is intended here. The following are examples of nouns used herein which are functional in nature:

### Reference Command Providing Means

A reference command providing means is a device which provides a reference command to a logic control processor. It may be a simple array of numbers stored in conventional memory or may be program command which executes an algorithm to generate a reference command to be provided.

Comparison Means (comparator)

A comparison means, herein ‘comparator’, is a device for comparing a first command to a second command and returning a binary result in agreement with the comparison. The comparison may be one which tests for coincidence between commands or one which tests for cooperation between commands. For example, if the commands are identical a binary ‘1’ can be returned or if the commands are different but merely cooperate under some rule, a binary ‘1’ can be returned.

### Interface Means

An ‘interface means’, herein ‘user interface’, is a device which allows a user to transmit to a logic processor a command.

### Interruption Means

An ‘interruption means’, herein ‘ignition interruption circuit’ or ‘ignition interruption mechanism’, is a device which causes interruption of critical systems of equipment.

Terms which are functional in nature like those above may be used throughout this disclosure including the claims. For example, ‘means for’ or ‘step for’ followed by a phrase describing a function. One should remain mindful that any particular object provided as an example is not meant to limit the functional noun to that example but rather the example is provided to further illustrate certain preferred possibilities. Thus the ‘means for’ or ‘step for’ should not be limited to any particular structure which may be called out but rather to any conceivable means of causing the function described to be effected. The reader will recognize it is the function to be carried out which is the essence of the invention and many alternative means for causing the function to occur may exist without detracting from any combination or combinations taught as part of the invention.

Although preferred embodiments discussed here in detail are primarily directed to automobiles, one will appreciate that other types of equipment may be equally subjected to similar programs intended to protect a lender. For example, ‘equipment’ may include an air conditioner where a compressor is a critical system which may be interrupted. Alternatively, equipment may be an elevator having a control module as a critical system. Thus, operation of the elevator can be controlled in response to on-time loan payments. Any equipment which exposes a critical system to an interrupt means may be coupled to systems of this invention whereby operation of the equipment can be held as encouragement to repay loan payments in accordance with loan terms. Thus the true breadth of the invention should be limited only by the claims attached hereto without regard for particular examples set forth here for illustration.

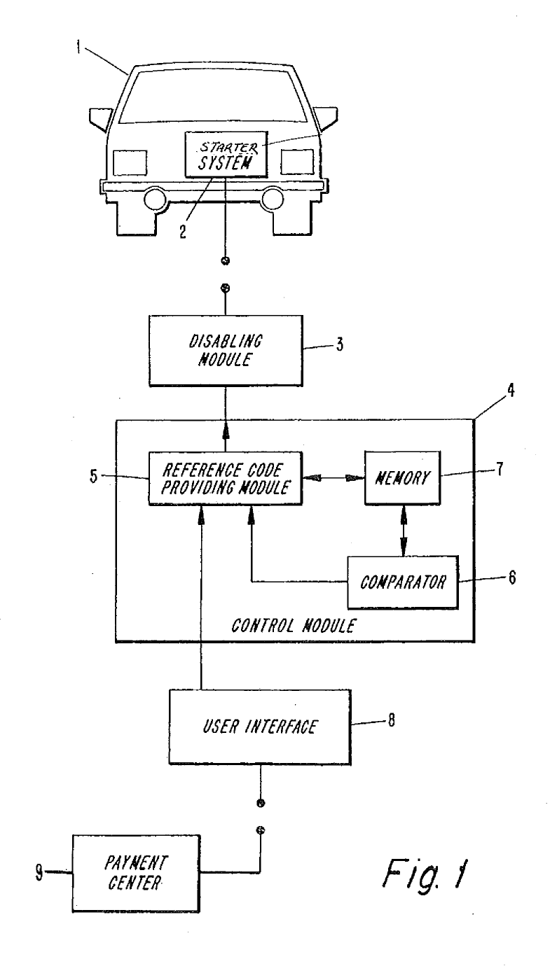

With reference to the drawing figures a full and complete appreciation of best modes of the invention can be gained. FIG. 1 illustrates a block diagram of basic apparatus of the invention. An automobile 1 having a standard ignition system 2 is in electrical communication with a device of this invention. The device comprising: an ignition interruption mechanism 3; in communication with a logic processing unit 4; including a reference command providing means 5, a comparator 6, and a memory 7; is further in communication with a user interface 8. A payment center 9 which provides commands to a user is also depicted. Although the automobile and payment center are not considered elements of apparatus taught here, they relate intimately therewith thus they are shown via their relationship with elements of apparatus.

### Critical System Interruption Circuit

An ignition interruption circuit may be coupled to ignition wires leading from a standard ignition keyswitch. In simplest terms, the ignition interruption mechanism may be described as a circuit breaking switch. Arranged serially, either switch, the keyswitch or the ignition interruption mechanism, will operate to cause an open circuit in the ignition primary rendering the ignition disabled. An ignition interruption circuit is further in communication with a logic processing unit. The logic processing unit operates the ignition interruption circuit in accordance with events which occur there. The logic processing unit generates commands to direct the ignition interruption circuit to take either of two alternative states. A ‘disabled’ state corresponds to an ‘open’ ignition circuit while an ‘enabled’ state corresponds to a ‘closed’ ignition circuit. The logic processing unit causes the ignition interruption circuit to switch between these two states. In another embodiment, an ON/OFF of the starter due to a command can enable or disable the equipment.

### User Interface

A user interface is coupled to the logic processing unit in order to convey to it a command. An alpha-numeric type command such as a PIN number for example, may be transmitted from the user interface to the logic processing unit for comparison to a reference command. While preferred versions of the invention include a simple keypad for tactile entry of a numeric command by a user, other versions are possible. Tumbler combination locks, slider element devices, and point-and-click user interfaces all are examples of alternative forms of user interfaces. A user interface is provided to allow a user to convey a command to a computer. Accordingly, use of an alternative user interface will not lend novelty to any version of an apparatus not explicitly presented here. A user interface allows a user in communication with a payment center to receive commands therefrom and cause those commands to be entered and transmitted to the logic processing unit for comparison.

### Logic Processing Unit

A logic processing unit may be a microcontroller of a standard sort sometimes referred to as ‘off-the-shelf’ devices or alternatively may be a custom designed microcircuit having specific application. Although strictly speaking a ‘logic processing unit’ may be distinct from support elements such as a memory, for purposes of this disclosure ‘logic processing unit’ is used to refer to the entire computing facility which may include a memory, a comparator and other support elements. FIG. 1 shows this relationship where a reference command providing means 5 and a comparator 6 are presented within the bounds of the microcontroller 4. The logic processing unit may include other support elements such as power supply control, read-only memory, input-output facility, and other elements typically used in conjunction with microcontrollers or microprocessors. Logic processing units of the invention are set to execute command which is predetermined at an initialization step. As the preset command is not dynamic, the logic processing unit is not considered a user-programmable device. Its purpose is to execute command instructions which enable the functionality described herein this disclosure.

The logic processing unit can communicate with multiple relays, e.g., three relays, simultaneously. For example, one main wired and two wireless relays that add an anti-tamper layer to the device. In case the logic processing unit is removed or tampered with and is no longer within useful proximity, a main wired relay can disable the vehicle. The two wireless relays will look for the logic processing unit and can disable the vehicle or equipment to which it might be attached.

A grace period may be included as part of the deadline for payment. Under terms of the loan, a payment becomes due at some discrete time. However, because of inconsistencies in the mails or other payment transmission difficulties, systems of the invention may be arranged to provide a grace period. A grace period allows equipment to operate normally after the time for payment has past but where no payment has been received, recorded, and reported via communication of a command. During the grace period, various indications and warnings may be provided to a user at the equipment. For example, a display may be arranged to deliver a message which indicates impending interruption. Alternatively, an audio signal may be provided to alert a user to the condition that payment is overdue.

One will appreciate that in rare cases of emergency, provision for override may be useful. For example, if a car is disabled for lack of timely payment, then a special command to be used only in case of emergency may temporarily re-enable the car. Thus a person in dire need of medical help may be transported with an otherwise disabled car when the emergency command is employed. By agreement, one can be charged heavy fines for misuse of emergency commands. In this way, non-emergency use is highly discouraged. The system is made secure against use outside designed limits while still accommodating occasional emergencies.

Fraudulent attempts to enable equipment may be accompanied by surreptitious entry of random commands. This may easily be detected at the logic processor and devices of the invention may be arranged to respond. When a predetermined number of bad command entries is detected, the system may be made to block further entry of commands. For example, when three consecutive bad commands are attempted, the system can be made to ignore further entry for a predetermined amount of time.

Some alternative versions of the invention omit use of a user interface. Where stationary equipment can easily be put into automatic communication with a payment center, for example via a simple telephone line connection, a user interface may be replaced by a modem and telephone line. The logic processing unit can then receive transmission of commands directly from the payment center without user input whatever. One will appreciate that there is nothing sacred about a telephone line hook-up and other communication means may work in similar fashion. Paging technology which transmits messages by radio frequency also works well. Equipment having a pager in communication with a logic processor unit could receive commands to activate the systems. Thus, any means of conveying a command from a payment center to a piece of equipment should be considered as part of the invention.

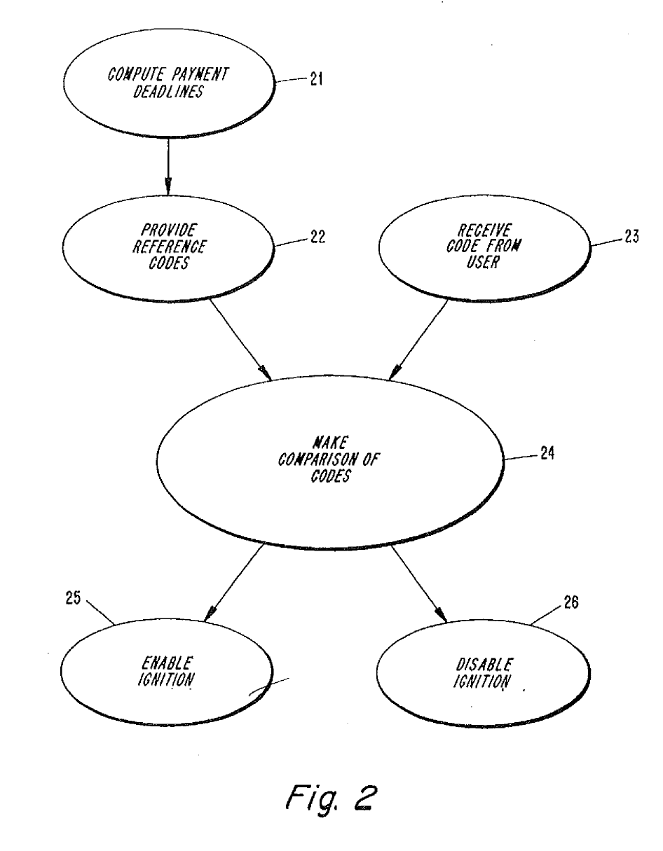

With reference to drawing FIG. 2, preferred methods of the invention include a step to compute a plurality of payment deadlines 21. In agreement with repayment terms of an automobile loan, a plurality of deadlines for receipt of payments is provided. Information relating to date and time of loan initialization, lifetime of the loan, total number of payments to be made, payment frequency, grace period, emergency override command, and perhaps other information (i.e. re-enable, reset procedures), is used for computing payment deadlines. A payment deadline represents the time by which a payment must be received at a payment center in order that the terms of the loan be met. Payment deadlines may be computed at initialization of the (loan) system or may be computed at various times thereafter initialization. In either case, deadlines computed may be used to generate reference commands.

In some versions of the invention, a host/client relationship is established with regard to computing facility. A host which may run software appropriate for systems administration can be connected to a client computing apparatus for downloading of important data like command schemes and particular deadlines. After initialization operations, the host may be separated from the client where the client has been programmed with important command information.

A logic processing unit includes facility to provide reference commands which correspond to computed deadlines. Algorithms used to generate reference commands are well known to the payment center which supplies corresponding commands to a user. A careful observer will note that the reference command provider may be arranged to merely store an array of reference commands generated in a set-up procedure during initialization of the system. The reference commands are then periodically recalled from the memory for a comparison step. As an alternative, it is possible to generate reference commands in real time in agreement with some algorithm. For example, a useful reference command may simply be a number equal to the number of days since a predetermined date set at initialization. In either case, the reference command providing means of the logic processing unit provides a reference command 22, whether it be from memory or one generated in real time, to a comparison means or comparator.

In a parallel step 23, a command may be received from a user. This may occur at any time prior to a present payment deadline without causing interruption of the ignition. A user having made a timely payment, that payment having been properly received and logged in the payment center, is entitled disclosure of the command which releases the mechanism from causing an interruption. In preferred embodiments, a user mails a payment to the payment center in advance of the deadline. When enough time has passed for the center to have received and processed the payment, the user can call the payment center on a telephone and identify the loan. In response, the payment center can check its database and verify receipt of payment. After verification, the payment center will disclose to the user the command which can be used to release the timed interrupt mechanism. Having received the command, the user can then send the command to the device via the user interface application or enter a command via the user interface application that will send the command to the device. Thus, in methods of the invention, a command from a user is received at a user interface application.

A comparison of command 24 is made in the logic processing unit. Upon receipt of a command from the interface application, the logic processing unit is triggered to perform a comparison of command. The reference command which corresponds to an immediate payment deadline is compared to the command received by the user interface application. One of two results dries the next step. If there is agreement between the commands, the logic processing unit generates the interruption circuit to leave the ignition (or starter) 25 without interruption. If there is no agreement between the command received and the reference command, then the logic processing unit generates the interruption circuit to cause disablement of the critical system 25.

It is important to note that, if agreement exists between the entered and reference commands, the result of the comparison step sets a positive indicator in the logic processing unit, which indicator must be present at the occurrence of the payment deadline to avoid causing the critical system to be interrupted .

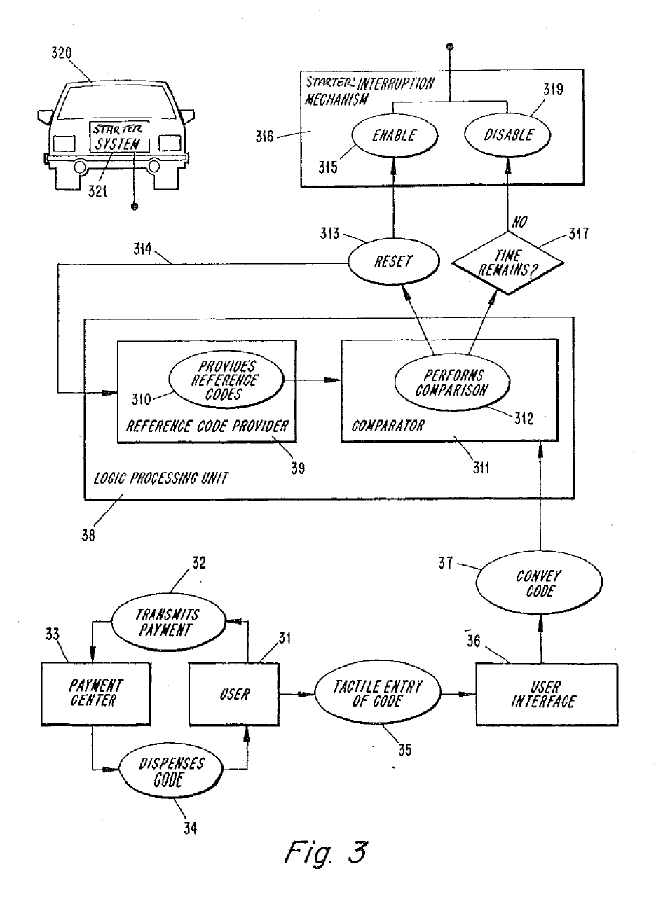

FIG. 3 illustrates one preferred version of the entire system with more precision where steps of methods are shown in their relationships with elements of devices. A user 31 causes a payment to be transmitted 32 to a payment center 33 where it is received and logged into records. In response to receipt of that payment, the payment center dispenses 34 a predetermined command to the user. The user then receives 35 the command via a user interface application which is sent to the device 36, e.g., a simple mobile application. The user interface conveys 37 the command to the comparator portion of a logic processing unit 38. A reference command provider 39 provides 310 a reference command to the comparator 311. A comparison operation 312 is made to arrive at either of two distinct results. Either agreement is found with regard to the reference command and the command entered by the user, or no agreement is found. In the case of agreement, a reset operation 313 sends feedback 314 to the reference command provider to determine a new reference command which corresponds to the next payment deadline, while an enable 315 step causes the ignition interruption (or other critical system) circuit 316 to be operated such that the ignition is enabled without regard to its prior state.

In the case where agreement is not found, an agreement indicator is left in a negative state. On arrival of a payment due deadline or end of a grace period a check of the state of the indicator is made. If the indicator is in a negative state, the ignition interruption (or other critical system) circuit is operated to cause the ignition to be disabled 319. Devices of the invention may be coupled to an automobile 320 having a standard ignition 321.

In some preferred embodiments, when a payment deadline passes, a grace period begins. During the grace period, the user is notified via an indicator, for example a visual or an audio signal, that the grace period has been activated. During the grace period, the equipment remains operable and the ignition (or other critical system) is not interrupted. However, the indicator serves as a warning of the impending interruption in service. If the grace period is exceeded and proper command has still not been entered, then the equipment is disabled. This embodiment is considered a mere subset of the above described systems. The grace period being a limited extension of time before interruption of the critical system occurs.

Alternative versions exist where the user interface is made redundant and is omitted entirely. For example, in the case of equipment which is an elevator or air conditioner a user interface can be eliminated and the system made automatic. The system can easily be put into automatic communication with a payment center, for example, via a simple modem and a telephone line connection if “stationary”, or via a wireless modem connection interface where equipment is “mobile.” In this way the logic processor of the air conditioner is put into communication with the payment center via a modem or wireless modem. The air conditioner can automatically be put into communication with the payment center on a periodic basis to receive commands which may be made available in response to receipt of payments.

The advantages of the present invention include that it can be used in connection with a method which accounts for the self-contained monitoring of the payment status that are connected with or without a vehicle location system.

The previously-identified systems have a number of limitation and deficiencies of prior methods and systems that are overcome with the present invention. In accordance with the present invention, an in-vehicle communication gateway communicates with the vehicle disablement device and received the commands via a mobile application removing the burden for the user to input codes in to the device (imputing codes into the device will be used only in the case of emergency or as a backup method if the user does not have their mobile device with them). The mobile application automatically sends the payment command to the vehicle disablement device once the user has entered the vehicle and a payment command needs to be sent to the vehicle disablement device via the communication gateway. The mobile application provides the time and location of event of connecting with the communication gateway within the vehicle and the status of the equipment within the vehicle and the commands communicated within the vehicle. When the payment is not sent to the vehicle disablement device via the mobile application if a payment due date associated with the vehicle has passed and a payment has not been received for the vehicle. The mobile application will access the location system within the mobile device operates to provide the vehicle's location to a service agency. The service agency can then locate and repossess the vehicle. The vehicle disablement device will communicate via the communication gateway to the mobile application that a payment is past due. The Mobile application will provide the information including the time and location of the connection that will trigger an event to the service agency can be a lender or other party having a security interest in the vehicle. Alternatively, the service agency can have a contract with a party who has an interest in the vehicle to locate and repossess vehicles for which payments are delinquent. Additionally, the communication gateway can be activated in discover mode if it is detected that the vehicle is being tampered with sending a signal that can be picked up by any device that has been enabled with an application to receive the signal which will communicate the location of the communication and the gateway ID thus the location of vehicle can be determined using global positioning satellites or by triangulation using base stations in mobile radio systems.

In accordance with one embodiment of the present invention, a vehicle disablement device installed in a vehicle determines whether a certain date has passed. If the certain date has passed the vehicle disablement device determines whether a command associated with the date has been previously received into the vehicle disablement device if not the vehicle disablement device will disable the vehicle. If a command associated with the date has not been previously received then the vehicle disablement device will activate the communication gateway that will activate a signal that communicates with enabled devices within proximity that will provide a location of the vehicle to a service agency. The service agency can then recover the vehicle. Further, if it is detected that the vehicle disablement device has been tampered with, the vehicle disablement device, or a tamper detection device, can activate the communication gateway to communicate the event to any enabled device within proximity and provide the location of the vehicle to the service agency.

By using the communication gateway and locally activating it to communicate with an enabled mobile device, the burden of installing location system is eliminated; the burden of monitoring payments for a vehicle by a service agency can be reduced. Further, the cost of the cellular SIM that is used by location system is reduced since the system will be communicating via any enabled mobile device within proximity.

In accordance with each of the exemplary embodiments of the invention, there is provided apparatus for and methods of a location of vehicles. It will be appreciated that each of the embodiments described include both an apparatus and a method and that the apparatus and method of one exemplary embodiment may be different than the apparatus and method of another exemplary embodiment.

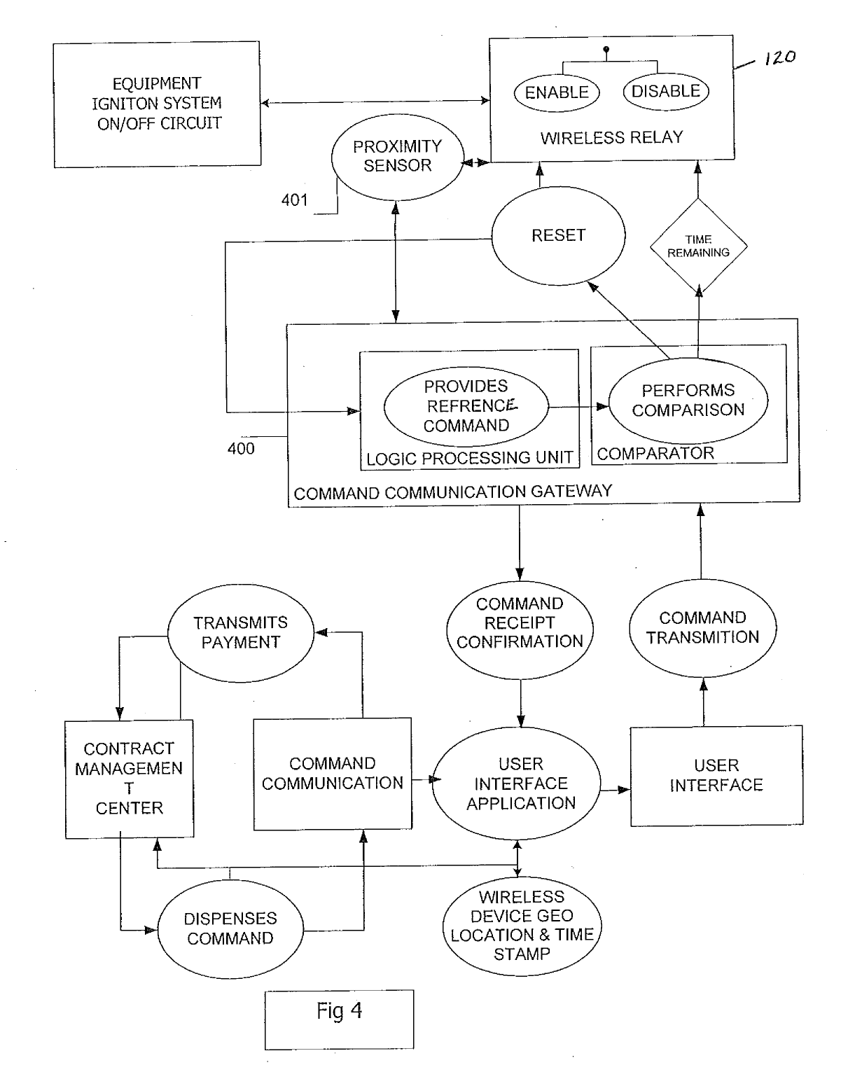

FIG. 4 illustrates a vehicle with a vehicle disablement device and a wireless communication Gateway system 400 in accordance with exemplary embodiments of the present invention. As illustrated in FIG. 1, a vehicle which is equipped with a vehicle disablement device 120 can also include a communication Gateway system 400. In accordance with exemplary embodiments of the present invention, if it is detected that vehicle disablement device 120 has been tampered with; communication Gateway system 400 will be activated to provide a signal that will communicate the event that will communicate with any receivers within range that will communicate the location of the signal received and the communication Gateway system unique ID. Further, if it is determined that a payment has not been received within a predetermined amount of time, vehicle disablement device 120 will disable the vehicle and activate the communication Gateway system 400 to provide the location, through the proximity sensor 401, in which the signal has been received thus communicating the location of the vehicle.

The new gateway system allows many advantages. The gateway can enable any device that has an On/Off switch, or known as an I/O, to be converted. The wired enable/disable feature of the device is converted by the communication gateway, which will send an On/Off signal to a wireless relay that will enable or disable the equipment, or even turn a light On/Off without the need of a wire connection. This is possible and beneficial for any equipment that uses traditional wired relay systems to be converted to wireless system without the need to change the legacy system or running cables across or from the unit to the location of the I/O or relay. This also allows turning a unit, e.g., an AVL, telematics or M2M device, into an anti-tamper device.

The gateway system for wireless enablement and the relay can be paired at the factory. In one embodiment, the pairing of the gateway and relay would work as follows:
1) Both Relay and Gateway are powered off.
2) Relay has 4 wires, RED+12 VDC, BLK=GND, and STARTING and STAROUT both BLUE. Power RELAY with one of the BLUE wires at +12 VDC. One can hook one of the BLUE wires to the RED wire and then apply +12 VDC. The RELAY is now in LEARN mode for about 15 seconds.
3) While RELAY is in LEARN mode apply power to GATEWAY. They are now paired.

2 blinks on GATEWAY Dongle mean communication unsuccessful.

1 blink on GATEWAY Dongle means successful communication.

Among other features, the pairing of the gateway with the relay offers the following advantages:

3 start attempts after losing communications—

As long as the RELAY is powered it will communicate START or No Start. If one powers off the GATEWAY, the RELAY will eventually go into a No Start condition. However, the RELAY allows 3 starts after it has not been communicated to. To test this out, one can disconnect power from the GATEWAY, wait 5 minutes, then try starting. The RELAY will allow 3 starts after losing communication. Each start attempt must be separated by 5 seconds of no start. If one attempts a start (it starts), then release and re-apply the start within 5 seconds, this still counts as 1 start attempt. So one must wait past the 5 seconds before the RELAY considers it a start attempt (one gets 3 of these start attempts after loss of communication).

RELAY has fuel interrupt and Ignition interrupt capability feature—

Once a RELAY has allowed a vehicle to start it will continue to do so within 5 seconds. It must see both blue wires low for at least 5 seconds before it shuts the vehicle down. For example: Let's say that a customer is operating their vehicle for 2 hours. The vehicle gets the signal (lack of signal in this case) to shut the vehicle down. It won't shut down until it sees that both blue wires are not energized for a total of 5 seconds (i.e. it won't happen until the customer has turned the vehicle off for 5 seconds, not while the customer is driving). So during any testing at the factory or on a vehicle after commanding the vehicle to shut off (removing GND on IN1), one must wait 5 seconds before attempting to re-start the vehicle otherwise it will allow the vehicle to start within the 5 seconds again.

In accordance with an embodiment of the present invention, the vehicle disablement device includes a keypad and a wireless receiver for receiving commands from the owner to prevent disablement of the vehicle. Specifically, the vehicle disablement device contains a plurality of commands corresponding to a plurality of dates for payments associated with the vehicle. If the payment disablement device does not receive a commands from the mobile application or via the keypad which corresponds to the stored commands prior to a payment due deadline, the vehicle disablement device prevents the vehicle from operating. The vehicle disablement device prevents the vehicle from operating by disabling a critical system of the vehicle.

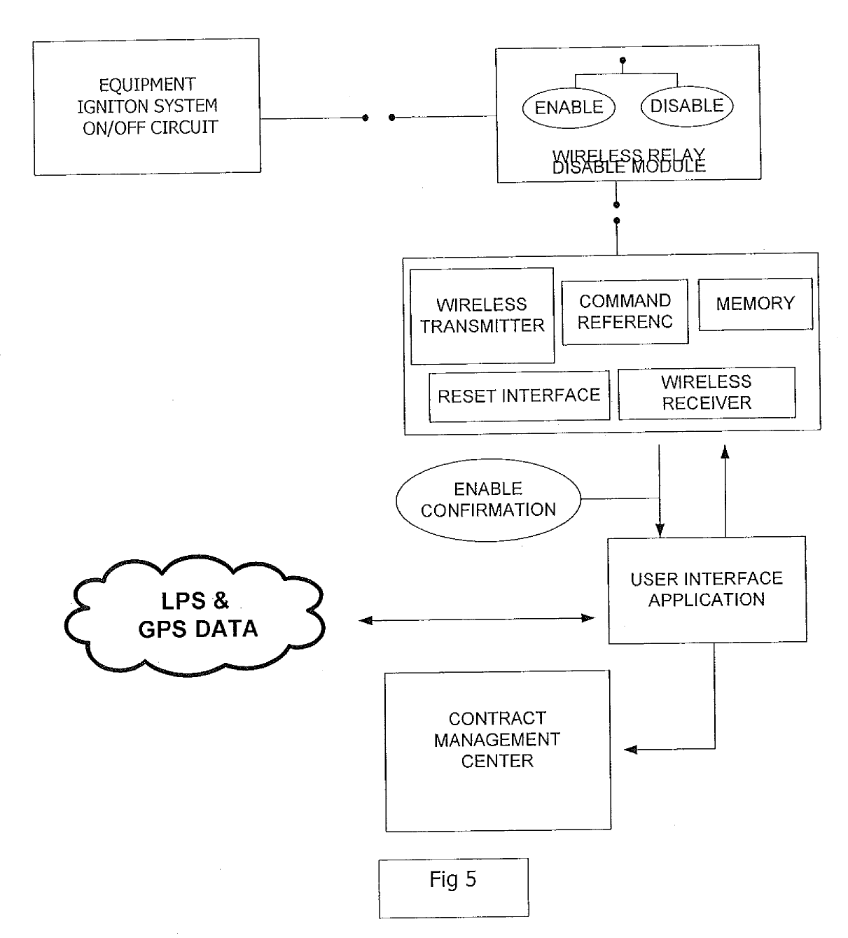

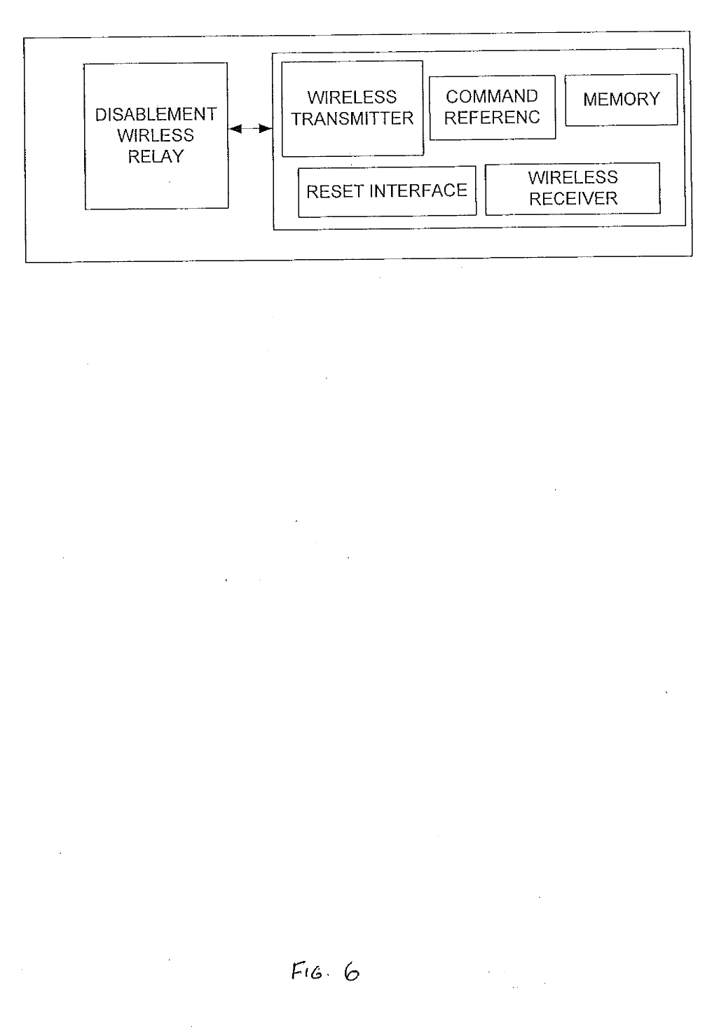

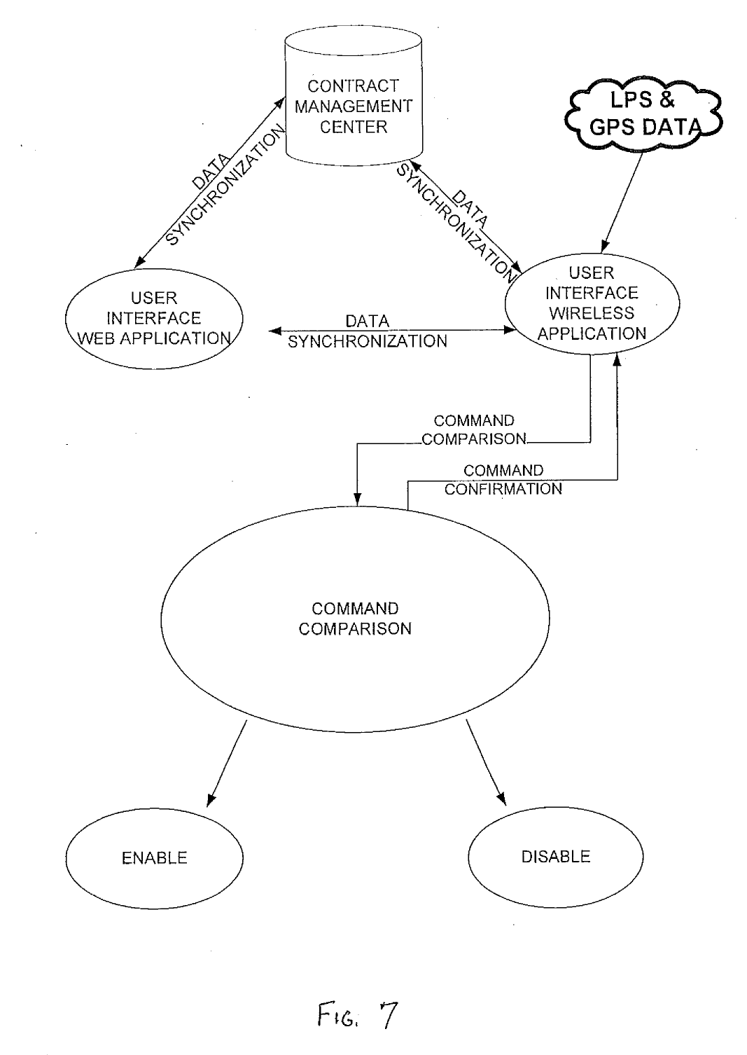

FIG. 5 illustrates the details of a user interface mobile application in accordance with exemplary embodiments of the present invention. FIG. 6 illustrates the user interface. In accordance with exemplary embodiments of the present invention, the user interface application will communicate the current location of communication with the communication Gateway system 400 and return all the information to a server application which includes a location of communication, Gateway unique ID, Time and Date of the communication and the command that was communicated with the vehicle disablement device. Upon activation of the mobile application that will assess the location system within the mobile device, which determine the current location of communication that will determine the location of the vehicle. In accordance with exemplary embodiments of the present invention, location determining device is a global positioning satellite (GPS) receiver within a mobile device. As shown in FIG. 7, alternatively, the location of the vehicle can be determined by triangulation based upon signals from three base stations by the mobile radio communication system which receives the signal from the gateway installed in the vehicle determining the location of the vehicle, or any other location determining technique.

After the location of the vehicle has been determined from the communication between the mobile application and the communication gateway and the location of the vehicle is determine. The location of the mobile device can then be provided, that location of the occurred communication of the device within the vehicle to a service agency responsible for ensuring payments are made on the vehicle. In accordance with exemplary embodiments of the present invention, a location providing application on a mobile telephone. Although the signal providing device and the location providing device are illustrated in FIG. 5 as separate components, it should be recognized that these can be designed in a single component.

It will be recognized that many features of conventional mobile telephones will not be required for providing the location of the vehicle. Instead the location providing device can be a device which has only the ability to access the cellular system and provide the current location of the vehicle. In other words, it is not necessary that the location providing device include a receiver and associated circuitry. Further, the location providing device need not be equipped to access voice channels of cellular systems. Instead, the location providing device and application can be designed to send the current location of the vehicle via short message service (SMS) commonly employed in cellular systems. Alternatively, the location providing device and application can access dedicated packet data channels which are now implemented in mobile radio communication systems and (PND) Portable Navigation Device.

FIG. 4 illustrates an exemplary method in accordance with the present invention. Initially, it is determined whether tampering with the vehicle disablement device or with the communication gateway has been detected. If tampering with the vehicle disablement device has not been detected (“NO” path out of decision), it is determined whether payment has not been received for a predetermined amount of time, i.e., it is determined whether a payment due date has passed. If all payments are current (“NO” path out of decision) then it is again determined whether the vehicle disablement device has been tampered with. Although this has been described as determining whether tampering with the vehicle disablement device has occurred, this step can also include determining whether tampering with was due to a loss of connection between the vehicle disablement device and the communication gateway via the proximity sensor, or any other portion of the vehicle has occurred. For example, tampering with the battery of the vehicle can activate the proximity sensor.

If it is determined that a payment has not been received for a predetermined amount of time (“YES” path out of decision), the vehicle disablement device will automatically activate sending a signal to communicate with the users mobile telephone application or any receiver device within proximity of the communication gateway communicating the time and location of the connection to the system. As discussed above, the search to listen to the communication gateway on a device which can be implemented on a mobile telephone can be activated remotely. Accordingly, the mobile telephone can be called from a service agency to activate search to listen feature via the application and access the location system within the mobile device.

If it is determined that the vehicle disablement device has been tampered with (“YES” path out of decision), the vehicle disablement device, or a tampering detecting device, will locally activate the signal that will communicate with any system that has been equipped with the application that will communicate the location of such connection.

Once the communication gateway has been activated, either locally or remotely via the application, which will access the location system on the device providing the vehicle location or the location of the connection made to a location service agency. The location service agency can then provide the vehicle location to a service agency which is responsible for the payments made on the vehicle it will be recognized that the vehicle location can be provided directly to the service agency, thereby eliminating one of the steps. Further, the location service can be sent to a mobile device with navigation capability that will enable the recovery agency to navigate to the location of the vehicle or post the vehicle's location on a secure web page for the service agency to retrieve the vehicle location from.

The status of payments is monitored within a device located in the equipment to be disabled. It should be recognized that the monitoring of the status of payments by these devices is performed implicitly, since the disclosed devices are designed such that the equipment is disabled if a command is not received by a certain date or time, i.e., a payment due date. The certain date used for these devices can be a date which is repeated on an hourly, daily basis, weekly basis, monthly basis, or any other type of time basis.

The advantages of the present invention that it can be used in connection with the method which accounts for the self-contained monitoring of the payment status.

In the case that a vehicle location system is installed where If the command associated with the certain date has not been received into the equipment disablement device (“No” path out of decision), then the vehicle is locally disabled by the equipment disablement device without receiving any signals outside of the vehicle and the communication Gateway system is locally activated. If, however, the command associated with the certain date has been received into the equipment disablement device (“Yes” path out of decision), then it is determined whether tampering has been detected in accordance with the return path. The embodiment discussed in connection with FIG. 4 relies upon local activation, i.e., within the vehicle, of the communication Gateway system. This is especially advantageous as it results in a less costly and simplified system because the system does not require a receiver to be located in the vehicle. Accordingly, the communication Gateway system only requires a transmitter a signal to that will be received by the location device that will relay its location. Further, the local activation reduces the amount of monitoring required by the finance company, or other party which has an interest in the vehicle, since the company knows that the vehicle disablement device will contact the finance company with the location of the vehicle if a payment has not been made or if the vehicle disablement device has been tampered with.

Although not illustrated in FIGS. 3 and 4, these methods can also include the steps of: the vehicle disablement device comparing the commands received from the user with commands stored in memory; and if there is a match, storing an indication in the vehicle disablement device that the command has been entered, thereby allowing the user to operate the equipment associated with the vehicle disablement device until the date and/or time associated with a command which has not been entered has occurred. Further, the disablement device can include a plurality of lights, e.g., light emitting diodes, to indicate if the end of a payment period is up-coming. For example, a green light would indicate that no payment is due; a yellow light would indicate that a payment is due shortly, and a red light would indicate that a payment is due immediately or the equipment will be disabled. Further, the lights can blink at an increasing frequency the closer in time it is to a payment due deadline. In addition to the use of lights to indicate whether a payment is up-coming or due, an audible beep or other sound can be used to indicate such. For example, a single beep can be used to indicate that a payment is up-coming and a constant beep can indicate that a payment is passed due.

The same methods of a reminder can be simulated within the mobile user interface application installed on the end users mobile device that will alert the user of the commands received from the server application and that the same commands need to be sent to the in vehicle device; once the user has send the command a confirmation of the received command if there is a match, storing an indication in the user interface application that the vehicle disablement device that the command has been received, thereby allowing the user to operate the equipment associated with the vehicle disablement device until the date and/or time associated with a command which has not been entered has occurred. The same mobile user interface application will capture the confirmation of the used command time stamp and geo location of the event by accessing the location based services of the mobile device and communicates the confirmation of the used command to the server application. Further, the mobile application can include a plurality of events triggers, to indicate if the end of a payment period is up-coming. For example, a green icon would indicate that no payment is due; a yellow icon would indicate that a payment is due shortly, and a red icon would indicate that a payment is due immediately or the equipment will be disabled. Further, the mobile user interface application will indicate to the user that it has not communicated with the vehicle disablement device for a predefined number of days which is set by the lean holder.

Although exemplary embodiments of the present invention have been described in connection with particular types of vehicle disablement devices, it will be recognized that the present invention is equally applicable to any type of vehicle disablement devices. Further, although exemplary embodiments of the present invention have been described in connection with a vehicle disablement device, it will be recognized that the present invention is equally applicable to any type of disablement device. Moreover, although the present invention has been described in connection with a loan, the present invention is applicable to any type of third party interest in a vehicle, including, for example, leases.

One will now fully appreciate how an electronic device is arranged and operates to encourage timely loan payments by disabling equipment. Further, that the device may be reset remotely and does not require being physically present at a loan center to be properly reset. Although the present invention has been described in considerable detail with clear and concise language and with reference to certain preferred versions thereof including the best mode anticipated by the inventor, other versions are possible. Therefore, the spirit and scope of the invention should not be limited by the description of the preferred versions contained therein, but rather by the claims appended hereto.

What is claimed is:

1. A method of enabling and disabling equipment in response to payments being timely made, comprising the steps of:
computing a payment due deadline of a loan agreement for said equipment;
generating a reference command which corresponds to said deadline; providing said reference command to a comparator via a computer interface;
receiving an additional command, via a user interface application;
passing said additional command to said comparator;
comparing said additional command with said reference command;
disabling a system which supports causing an ON/OFF event of equipment or ignition in an engine of the equipment, if agreement between said additional command and said reference command is not detected prior to said payment due deadline, wherein said system includes only components not dedicated to directly causing a spark to initiate combustion; and
enabling said system if agreement between said additional command and said reference command is detected.

2. A system for enabling and disabling equipment in response to timely payments being made comprising:
a disabling module connected to a system that supports causing ignition in an engine of said equipment;
a control module in communication with said disabling module; and
means for periodically receiving a command from a keypad and transmitting said command to said control module,
wherein said control module comprises:
a comparator;
a reference command providing module, said comparator being operable for comparing reference commands with received commands and triggering events in response thereto, and
said reference command providing module being operable for periodically providing reference commands to said comparator wherein said reference commands correspond to payments which are to be made;
wherein said disabling module disables the system that supports causing ignition when said command is not in agreement with said reference command before a predetermined time exceeds a predetermined deadline, and
wherein the system that supports causing ignition includes only components not dedicated to directly causing a spark to initiate combustion.

3. The method according to claim 1, further comprising the steps of:
computing a subsequent payment due deadline if agreement between said additional command and said reference command is detected; and
generating a new reference command which corresponds to the subsequent deadline.

4. The method according to claim 1, wherein said payment due deadline is used to generate the reference command.

5. The method according to claim 1, wherein the reference command is generated in real time using an algorithm.

6. The method according to claim 1, wherein said additional command may be received at any time prior to a present payment deadline.

7. The method according to claim 1, wherein agreement between said additional command and said reference command is detected if said additional command and said reference command are different, but cooperate under a rule.

8. The system according to claim 2, wherein said reference command providing module comprises a program command which executes an algorithm to generate the reference command.

9. The system according to claim 2, wherein said reference command providing module generates a new reference command which corresponds to a next payment due deadline when the received command is in agreement with said reference command.
